(19) United States
(12) Patent Application Publication
(10) Pub. No.: US 2020/0084057 A1
(43) Pub. Date: Mar. 12, 2020

(54) CONFERENCE SESSION MANAGEMENT WITH MODE SELECTION

(71) Applicant: Avaya Inc., Santa Clara, CA (US)

(72) Inventor: Jitendra Singh Wadhwa, Maharashtra (IN)

(73) Assignee: Avaya Inc., Santa Clara, CA (US)

(21) Appl. No.: 16/129,712

(22) Filed: Sep. 12, 2018

(51) Int. Cl. H04L 12/18; H04M 3/56; H04N 7/15

(52) U.S. Cl. CPC H04L 12/1822; H04N 7/152; H04M 3/563; H04L 12/1818

(57) ABSTRACT

Methods, systems, and computer readable media for conference session management are described. A first request is received from a user device to join a conference session. The first request includes a credential and an indication that the user device is to join the conference session in a passive mode. The credential received from the user device is verified. Upon successful verification of the credential received from the user device, the user device is added to the conference session in the passive mode, wherein audio and video from the conference session are not transmitted to the user device. A user device state indicator associated with the user device is set to passive.

### TECHNICAL FIELD

Embodiments relate generally to computer networks, and more particularly, to methods, systems, and computer readable media for conference session management and control.

### BACKGROUND

In a multitasking environment, there are many instances where a user may wish to perform other tasks contemporaneously with participating in a meeting or conference hosted via audio/video conferencing over a computer network, e.g., a conference call, a videoconference, etc. There are however, technical limitations that affect the user's ability to do so.

For example, there may be instances when the participant of a conference call is unable to attend a conference call/session due to other scheduled events at the same time as the conference session. Further, as additional examples, the participant may be busy in another call/conference, preoccupied with work, may be driving, etc. In such scenarios, the participant usually has options to skip the conference call, join in late, or join the conference call by reducing speaker volume level of a user device and setting the microphone to mute. In a scenario where the participant joins the conference call by reducing the speaker volume level, the participant may still have to remain partially attentive about the conference contents, like his name being called up during conversation or for obtaining information on any interested topic getting discussed in the conference. Further, such scenarios, can also present hurdles when the participant's inputs are valuable to other participants in the conference session.

Embodiments were conceived in light of the above mentioned needs, problems and/or limitations, among other things.

### SUMMARY

In general, some implementations can provide a computer-implemented method comprising receiving by a server, over a network, a first request to join a conference session from a user device, the first request including a credential and an indication that the user device is to join the conference session in a passive mode. In an embodiment, the passive mode is activated using a signaling channel of the network. The credential can include a username, a password, a conference session code, a participant identifier (ID), a caller ID, a telephone number, or combinations thereof. The method can also include verifying the credential received from the user device, and upon successful verification of the credential received from the user device, adding the user device to the conference session in the passive mode, wherein audio, video, speech to text, and text to speech, from the conference session are not transmitted to the user device in the passive mode, and setting a user device state indicator associated with the user device to passive.

In some implementations, the method includes determining by the server, based on the user device state indicator, that one or more user devices in a conference session are in the passive mode. The method can also include based on the determination, ceasing transmission of media from the conference session to the one or more user devices determined to be in the passive mode and transmitting media to other user devices in the conference session.

The method can also include receiving a second request to update a mode of the user device in the conference session to an active mode from the passive mode, and in response to receiving the second request, establishing a media channel. The media channel enables transmission of at least one of the audio, speech to text, text to speech, or the video from the conference session to the user device. The user device state indicator associated with the user device is set to active. In some implementations, the second request includes receiving a voice instruction from an operator of a second user device in the conference session to update the mode of the user device. In an embodiment, the voice commands are processed by a conference session server. The method can further include receiving the second request subsequent to sending a notification to the user device to update the mode of the user device.

The method can also include sending a sound notification, a visual notification, a text notification, or combinations thereof. In some implementations, the method can include transmitting text from the conference session to the user device after adding the user device to the conference session in the passive mode. The method can also include transmitting the user device state indicator associated with the user device to other user devices in the conference session. The method can further include causing the user device state indicator associated with the user device to be displayed by the other user devices.

In some implementations, the method can include receiving a second request to update a mode of the user device in the conference session to an active mode, and in response to receiving the second request, establishing a media channel between the user device and a conference session server that hosts the conference session. The method can also include transmitting at least one of the audio or the video from the conference session to the user device over the media channel and setting the user device state indicator associated with the user device to active. The method can further include receiving audio from another user device in the conference session and detecting that the audio includes a voice command to update the mode of the user device.

In some implementations, the detecting can include transcribing the audio using speech recognition and, determining that the audio is the voice command based on matching at least a portion of the transcribed audio with a device identifier of the user device or a user identifier of a user associated with the user device, and based on detecting an activation keyword.

In some implementations, the method can include establishing a calling-line-identification (CLI) connection to the user device in response to successful verification of the credential received from the user device. The method can also include automatically changing the user device state from active to passive when the participant accepts a second communication session on a second communication line while attending the conference session in active state, wherein changing the user device state does not activate call-on-hold feature for the conference session participants. Similarly, the method can also include automatically changing the user device state from active to passive when the participant accepts a notification to join a third communication session, scheduled in a calendar.

Some implementations can include a system comprising one or more processors coupled to a non-transitory computer readable medium having stored thereon on software instructions that, when executed by the one or more processors, cause the one or more processors to perform operations. The operations can include receiving over a network, a first request to join a conference session from a user device, wherein the first request includes a credential and an indication that the user device is to join the conference session in a passive mode. The passive mode joins the participant to the conference session through a signaling channel.

The operations can also include verifying the credential received from the user device, and upon successful verification of the credential received from the user device, adding the user device to the conference session in the passive mode, wherein audio, video and live speech to text conversation, from the conference session are not transmitted to the user device in the passive mode, and setting a user device state indicator associated with the user device to passive. The operations can further include receiving a second request to update a mode of the user device in the conference session to an active mode and transmitting the audio or the video from the conference session to the user device and setting the user device state indicator associated with the user device to active in response to receiving the second request.

In some implementations, the second request can include receiving a voice instruction from an operator of a second user device in the conference session to update the mode of the user device. The voice instructions are processed by a conference session server. The operations can include transmitting text from the conference session to the user device. The operations can further include transmitting the user device state indicator associated with the user device to other user devices in the conference session.

In some implementations, the operations further include receiving a second request to update a mode of the user device in the conference session to an active mode, and in response to receiving the second request, establishing a media channel between the user device and a conference session server that hosts the conference session. The operations can further include transmitting at least one of the audio or the video from the conference session to the user device over the media channel and setting the user device state indicator associated with the user device to active.

Some implementations can include a non-transitory computer readable medium having stored thereon software instructions that, when executed by one or more processors, cause the one or more processors to perform operations. The operations can include receiving over a network, a first request to join a conference session from a user device, wherein the first request includes a credential and an indication that the user device is to join the conference session in a passive mode. The passive mode enables the user device to send and receive notifications. The operations can further include verifying the credential received from the user device, and upon successful verification of the credential received from the user device, adding the user device to the conference session in the passive mode, wherein audio and video from the conference session are not transmitted to the user device in the passive mode, and setting a user device state indicator associated with the user device to passive.

In some implementations, the operations can include receiving a second request to update a mode of the user device in the conference session to an active mode, and transmitting at least one of the audio or the video from the conference session to the user device, and setting the user device state indicator associated with the user device to active in response to receiving the second request. The operations can also include sending a notification to the user device to update the mode of the user device, wherein the receiving the second request is subsequent to sending the notification. The notification can include a sound notification, a visual notification, a text notification, or combinations thereof. The operations can further include, after the adding, transmitting text from the conference session to the user device.

In some implementations, the operations can include transmitting the user device state indicator associated with the user device to other user devices in the conference session. The operations can also include receiving audio from another user device in the conference session and detecting that the audio includes a voice command to update the mode of the user device. The detecting can include transcribing the audio using speech recognition and determining that the audio is the voice command based on matching at least a portion of the transcribed audio with a device identifier of the user device or a user identifier of a user associated with the user device, based on detecting an activation keyword.

### BRIEF DESCRIPTION OF THE DRAWINGS

FIG. 1 is a diagram of an example network environment in which a conference session may be conducted, in accordance with some implementations.

FIG. 2 is a flowchart illustrating an example conference session management and control method in accordance with some implementations.

FIG. 3 is a diagram illustrating conference session management and control in accordance with some implementations.

FIG. 4A is an example of a user interface for a conference host device in accordance with some implementations.

FIG. 4B is an example of a user interface for a conference host device in accordance with some implementations.

FIG. 5 is an example of a user interface for a user device in accordance with some implementations.

FIG. 6 is a diagram of an example computing device configured for conference session management and control in accordance with some implementations.

### DETAILED DESCRIPTION

A technical problem in conference session management is coordination of active and passive call participants, and enabling a participant to switch between a passive mode of participation and an active mode of participation, e.g., upon request from the participant or other participants in the conference session.

A participant may be unable to attend a conference session, but may be able to make themselves available as needed during the conference session while being a passive attendee. Additionally, the participant may wish to participate at specific times based on the topics of discussion during the conference session. One or more implementations may be a computer-implemented method to enable users to join a conference session in a passive mode, and switch subsequently to an active mode.

In some implementations, a passive mode of participation may be provided whereby a participant is joined in the conference session with the user device of the participant in a passive mode. For example, the passive mode may allow the user device to be added such that no media content from the conference session is sent to the user device in the passive mode. In another example, the passive mode may allow delivery of short textual content from the conference session but disallow media such as audio, video or live speech to text of conversation from the conference session. The mode of the user device of the participant can be updated to an active mode subsequently at a suitable time, e.g., upon request from the participant or other participants. In the active mode, the user device may receive audio and/or video from the conference session.

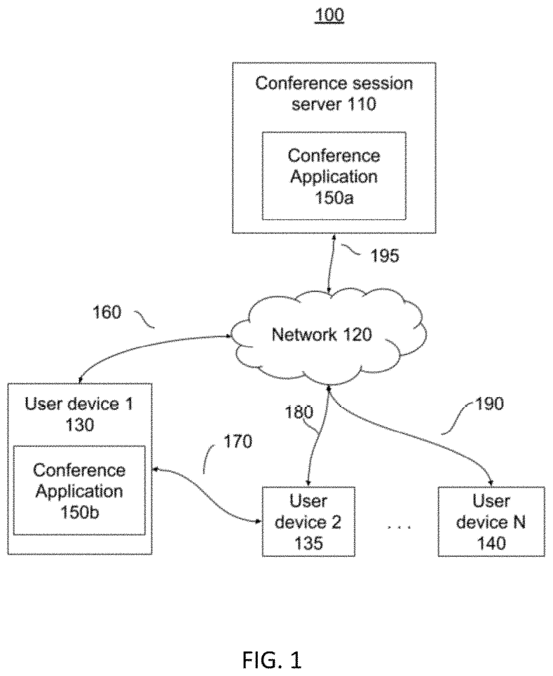

FIG. 1 is a diagram of an example conference session environment in accordance with some implementations. A conference session server 110 is configured to coupled to a network 120 via signal line 195. Conference session server 110 may be a computer, e.g., a server computer, a dedicated conference host device, an audio conferencing system, a video conferencing system, or any other type of device that enables multiple user devices to connect and participate in a conference session.

User devices 130 (User device 1), 135 (User device 2), and user device-N 140 may be coupled to network 120 via signal lines 160, 180, and 190 respectively. While FIG. 1 shows three user devices, any number of user devices may be included in the environment. A user device can be any type of electronic device, e.g., desktop computer, telephone, VoIP enabled phones and applications, laptop computer, portable or mobile device, cell phone, smartphone, tablet computer, television, TV set top box or entertainment device, wearable devices, personal digital assistant (PDA), media player, game device, etc.

Conference session server 110 and any of the user devices (130, 135, 140) may communicate with each other via network 120. While FIG. 1 illustrates a conference session server 110 separate from user devices (130, 135, 140), it will be understood that functionality of conference application 150 may be implemented entirely on one or more user devices 130-140, such that a conference session can be conducted between the user devices.

Network 120 can be any type of communication network, including one or more of the Internet, local area networks (LAN), wireless networks, switch or hub connections, a telephone network (e.g., a PSTN network, a cellular network, etc.) etc. In some implementations, network 120 can include peer-to-peer communication between devices, e.g., using peer-to-peer wireless protocols (e.g., Bluetooth®, Wi-Fi Direct, etc.), etc. One example of peer-to-peer communications between two client devices 130 and 135 is shown by signal line 170.

In some implementations, the conference session server 110 and any of user devices 130, 135, and/or 140 can include one or more applications. For example, as shown in FIG. 1, conference session server 110 may include conference application 150a and user device 130 may include conference application 150b. The conference application 150a may provide special functionality to manage and control conference sessions and the conference session server. User devices 135 and 140 may also include similar applications. In some implementations, user devices 135 and 140 may include the functionality of the conference application using voice commands, beeps, alphanumeric keypads, etc.

In some implementations, the user devices 135 and 140 may provide applications with limited functionality. For example, conference application 150b may provide a user of a respective client device with the ability to join, leave, and/or manage one or more conference sessions. For example, conference application 150b may be a software application that executes on user device 130. In some implementations, conference application 150b may provide a user interface. In some implementations, the conference applications 150a and 150b may use a voice-based interface (voice assistant), or may be configured to operate in conjunction with other voice assistants. In some implementations, conference applications 150a and 150b may include a speech/voice recognition engine. The speech/voice recognition engine may use any algorithm and/or machine learning techniques. The speech/voice recognition engine may transcribe audio from a conference session (convert into text) using speech-to-text technology, and may also recognize that particular phrases of audio were uttered by particular participants, by performing speaker identification, e.g., based on matching a stored voice fingerprint of a user with received phrases of audio.

In some implementations, conference application 150a may be a server application and conference application 150b may be a client application. In these implementations, conference application 150a may host conference sessions, e.g., enable exchange of media in real-time between one or more user devices in the conference session. In these implementations, conference application 150a may also facilitate operations to set a mode of a user device to passive or active, and selectively deliver media to particular user devices based on the mode. Further, conference application 150a may also receive user input to update a mode of a user device, and enable or disable media delivery based on the updated mode. In some implementations, conference application 150a may enable a user device to join a conference session via a telephone call, or via a data network. In some implementations, e.g., that exclude the conference session server 110, functionality of conference application 150a may be included in one or more of the user devices, e.g., in conference application 150b.

In some implementations, conference application 150b (for example, the Avaya Equinox communication platform or the Avaya Aura Contact Center, etc.) may be a client application that enables a user device to join a conference session. Client application 150b may enable a user to indicate a mode for the user device when it joins the conference session. Client application 150b may also provide a user interface to enable the user to select or update the mode while in a conference session. In some implementations, conference application 150b may also be responsible to display text, audio, or video from the conference session on a user device, and to transmit media and/or user input from the user device to the conference session server or other user devices. In some implementations, a user device may not include conference application 150b. In these implementations, the user device may join the conference session via a telephone call, and user input may be received via audio or touch-tone input on the user device.

In an exemplary embodiment, a user of the user device 130 joins the conference session in passive mode and users of the user device 135 and 140 joins the conference session in active mode. The users joining in the conference session (active mode or passive mode) after entering the conference call credentials like participant code, host code etc. The user credentials are either entered using a conference application installed on the user devices or through the conference IVR. As the user of the user device 130 joins the conference session in passive mode, a a signaling channel between the user device 130 and the conference session server 110 is established. The signaling channel is used for sending notifications and/or short text messages to the user device 130. For example, the user device 130 can receive a light notification to inform the user that his participation is required. Similarly, a small text information like “join” can also be sent to the user device 130 by the conference session server 110 in passive mode. The user device 135 and 140 establishes a media channel with the conference session server 110 as the user device 135 and 140 joined the conference session in active mode. Hence, the user device 135 and 140 can participate in the conference session using voice, video or live speech to text mode. This enables the user of the device 130 to be active in the conference session only when they are needed in the conference call. Moreover, the passive mode that disables media exchanges for the user device 130 (who are busy or is not interested to join) may conserve resources such as power, bandwidth, etc. at the user device and at the conference session server.

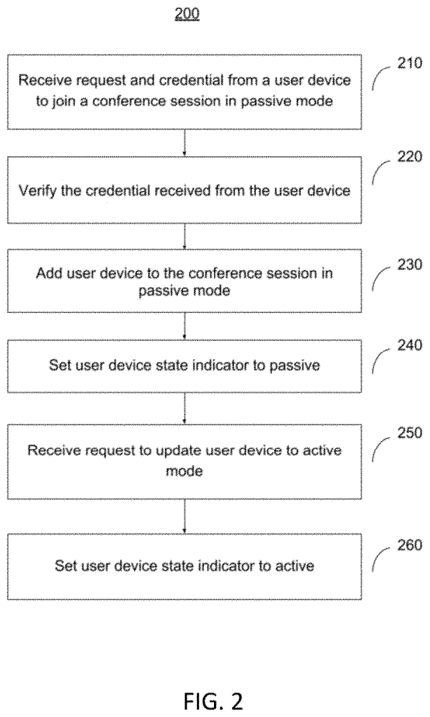

FIG. 2 is a flowchart showing an example conference session management and control method in accordance with some implementations.

The method 200 begins at 210, where a request and credential is received from a user device (e.g. a user device similar to one of user devices 130-140 illustrated in FIG. 1) to join a conference session in a passive mode. The request may be received at a conference session server (e.g. similar to conference session server 110 illustrated in FIG. 1). The user device is not joined to the session if the credential is not successfully verified.

The request to join a conference session may be transmitted using a conference application (e.g. similar to conference application 150b illustrated in FIG. 1). The request may include a credential and an indication that the user device is to join the conference session in a passive mode. In some implementations, the credential and the indication may be transmitted at the same time. In some implementations, the credential may be transmitted first, and the indication may be transmitted after transmitting the credential.

In various implementations, the credential may include a username/password, a conference session code, a participant identifier (ID), a caller ID, a Lightweight Directory Access Protocol (LDAP) identifier, a telephone number, or any combination thereof. In some implementations, the credential may be a numeric or alphanumeric code, e.g., a conference session passcode. In some implementations, the credential may be transmitted automatically from a conference application upon a user action of joining the conference session. In some implementations, the credential may be received via user input, e.g., via an alphanumeric keypad of the user device, via a voice command, etc.

In some implementations, a user (also referred to as conference participant, session participant, or participant) may use the conference application to select a meeting/conference, (e.g., from a list of upcoming conference calls presented to the user) that the user is not able to join. The user may be requested to provide a credential to join the conference. Once the credential is authenticated, the user may indicate a preferred mode of joining the conference session. For example, the user may select to join the conference in an active mode or a passive mode. In the active mode, the user device may receive live speech to text, audio and/or video from the conference session, based on a user-indicated preference. Further, in some implementations, recording of the audio and/or video may be permitted when the user device is in active mode. In the passive mode, the user device does not receive media from the conference session, or may receive limited media, e.g., text, from the session. Further, in the passive mode, the user device does not transmit audio/video from the user device to the conference session. In some implementations, both active and passive mode may allow provision of a user interface (e.g., a user interface displayed on a screen, a voice prompt, etc.) of the conference session, e.g., to enable the user to provide input or switch between modes. Processing continues to 220.

At 220, the credential (e.g. participant id, username/password, alphanumeric code, etc.) received from the user device is verified. Upon successful verification, processing continues to 230.

In some implementations, one or more device identifiers associated with the user device, user identifiers, and user device properties may be obtained and stored by the conference session server during the verification process. For example, device identifiers may include one or more of location information (e.g., a GPS location, a building, city, a state, a country, etc.) a phone number associated with the device, an IP address associated with the device, biometric identifiers (e.g., a fingerprint or other biometric associated with the user), conference room identifiers, etc. User identifiers may include, for example, conference host status, security status, employee status, participant affiliation, etc. The user identifiers and the device identifiers may be obtained as part of the credential.

At 230, the user device is added to the conference session in the passive mode. A signaling channel may be established between the conference session server and the user device. In some implementations, the signaling channel may be configured as an out-of-band signaling channel. In these implementations, the signaling channel is separate from a media channel that carries media (e.g., text, audio, video, etc.) of the conference session. For example, out-of-band signaling may be used for participant devices that are connected to the conference session via a data network, e.g., an IP-based network. In some implementations, for example, when a user device is connected via a PSTN or cellular telephony network, the signaling channel may be configured as an in-band signaling channel. In these implementations, touch tone sounds may be mapped to session management parameters. For example, a touchtone associated with the numeric key “7” may be mapped to a “mode switch” parameter such that selection of the numeric key “7” by the user causes the conference session server to change the user device mode.

The signaling channel may be utilized to transmit notifications and other metadata between the conference session server and the user device, and may be used for conference session management. For example, the signaling channel may be used for communication session parameters such as audio/video bitrate, audio/video codec to user, error rates, etc. Notifications sent via the signaling channel may include, for example, status changes such as users switching between passive and active modes, users joining or leaving the conference session, etc. For example, when a user provides input to change a participant from passive to active mode (or vice versa), such input may be conveyed to the conference session server via the signaling channel.

In some implementations, the server determines that particular devices in a conference session are in the passive mode, e.g., based on the status indicator. Based on the determination, the server turns off transmission of media from the conference session (audio, video, text, etc.) to the user device, while continuing to transmit such media to other user devices in the conference session. By selectively turning off transmission, the server conserves processing resources and power (e.g., that may otherwise be required to encode the session media) as well as resources and power to activate a hardware transceiver to transmit the session media over the network.

Further, a user device in passive mode may be configured to periodically monitor the signaling channel for any updates from the conference session server. Owing to such configuration, a user device in the passive mode conserves resources by reducing the need to activate a device transceiver to interact with the network, and for the device processor to process data received over the network, thereby saving energy, e.g., a mobile device in the passive mode spends energy only for the periodic monitoring of the signaling channel. In comparison, conventional devices that participate in conference sessions spend significant resources receiving and transmitting media, even when a user is not actively participating in the conference session. In the passive mode, other user device services such as a camera, microphone, etc. may also be switched off.

The passive mode may be configured in a variety of manners. In some implementations, audio data and video data from the conference session are not transmitted to the user device in the passive mode. In the passive mode, a user may be enabled to send and receive data to/from other participants in the conference session. In some implementations, text data may be transmitted between the user device and the conference session through a dedicated line or through a dedicated messaging application.

A calling-line-identification (CLI) connection may be established between the conference in response to successful verification of the received credential. In some implementations, text data received from the user device by the conference session server may be retransmitted to other participants in the conference session.

In some implementations, a ticker-like information display may be utilized as a user interface for display on a user device that participates in the conference session. The ticker-like interface may be utilized to communicate highlights from the conference session, without obstructing a main user interface being displayed on the user device in passive mode. The ticker-like user interface allows the user to focus on a current task while also receiving updates from the conference session, while the user device is in the conference session in the passive mode. Processing continues to 240.

At 240, a user device state indicator associated with the user device is set to passive. The indicator may notify a conference host and/or other users about the user device state, e.g., passive or active. Further, in some implementations, a voice announcement may be made in the conference session about users who may have joined the conference in passive mode. The announcement may serve to inform other participants about the participation of a user device in passive mode. An announcement may also be made when a mode of a user device is updated, e.g., from passive mode to active mode. In some implementations, the user device state indicator may be displayed on user devices associated with the participants in the conference session. Processing continues to 250.

At 250, a second request is received to update the passive participant to active mode. A request to update the mode to an active mode may be received during the conference session. For example, a user in passive mode may provide a user input to switch (update) to the active mode, e.g., since the user is now available and intending to participate in the conference session in active mode. In another example, a conference host or another participant in the conference session may request that a particular participant be switched to active mode, e.g., to enable the particular participant to listen in on the discussion and/or provide their input.

In some implementations, the request to update a mode of the participant to active mode may be transmitted by the out-of-band signaling channel. In some implementations, the request to update a mode of the participant may be transmitted by in-band signaling (for example, by using alphanumeric keys on a user device with predetermined mappings of specific keys to commands and requests).

The request to update a mode may be initiated by the user associated with the user device, or by a conference host, or by any of the users participating in the conference session (for example, users associated with other devices). In some implementations, the request to update the mode may be transmitted via a voice instruction from a conference host or an operator of any devices participating in the conference session. In an embodiment, the voice instructions are analyzed by the conference session server and enables the change of participant mode from passive to active mode and vice versa. In some implementations, the request to update the mode may be transmitted via an app.

A notification may be transmitted requesting the operator to join in an active mode. The notification may be a sound notification, a visual notification, a text notification, or a combination of the above.

In response to the request, the user device is joined to the conference session in active mode. In active mode, a media channel may be established between the conference session server and the user device. The media channel is used for the transmission of audio, video, and/or text data traffic between the conference session server and the user device. A user device state indicator associated with the user device may be set to active.

For example, a participant in a conference session may be unable to join a conference session as an active participant due to other commitments but may be willing to make themselves available to join during the call. In such a scenario, the participant joins the conference session (which he/she is unable to attend) in a passive mode and may remain as a passive participant on the call. Thereby, the passive participant does not receive any media from the conference session. However, the signaling channel allows the participant to be present on the conference session in notification mode and can switch to active mode (media mode) whenever needed without any re-authentication process. This may conserve resources such as bandwidth, power, etc. at the user device as well as the conference session server. Subsequently, the conference session host may switch the participant mode from passive to active either through the conference application app or based on voice based commands (for example, AACC). For example, the conference session host may use a voice command, “AACC please join passive participant ‘A’ and make them active.” The voice command is analyzed by the conference session server and sends a notification to the passive participant ‘A’ to become active. The notification could be a push message which the participant ‘A’ can accept or deny. In another embodiment, the notification is a light notification which blinks on the participant ‘A’ device.

In some implementations, received audio from another user device in the conference session may be transcribed into text the audio using a speech recognition technique. A portion of the transcribed audio may be utilized to determine that the audio is a voice command to update the mode of the user device. The determination may be based on matching a portion of the transcribed audio with a device identifier of the user device or a user identifier of a user associated with the user device, and based on detecting an activation keyword present in the transcribed audio.

In some implementations, user identifiers associated with the user devices that are stored in the conference session server may be analyzed by the conference session server to detect voice and other commands. For example, in some implementations, user devices operated by a conference host may be configured with a capability to switch a mode of various other participants from passive to active (and vice-versa). In some implementations, any participating user device may be configured with the capability to switch its own mode from passive to active (and vice-versa) and to provide input indicative of an instruction for another participant device to change mode.

In some implementations, user identifiers (for example, a voice signature) may be utilized for the interpretation of voice commands. The conference session server may analyze the received voice input to a stored voice signature to recognize a source of the received voice command, e.g. as a particular user.

Alternatively, the conference session host may enable this explicitly through their conference application. A notification may be sent to the passive participant informing them of the intended change of state in the meeting. The participant is enabled to join in active state by just using a single click since the user has already been authenticated.

In some implementations, the participant may communicate their unavailability, which may then be transmitted to the conference session host and/or other users via their respective conference applications or via an announcement in the conference session.

In some implementations, other software applications and hardware devices may be integrated with the solutions described herein for added functionality. In some implementations, as set forth above, voice assistants may be integrated. In some implementations, machine intelligence functionality may be included.

In some implementations, an agenda of a conference session may be stored by the conference session server and may be utilized to interpret commands and/or requests. For example, the agenda may include one or more items, and user identifiers of corresponding persons, e.g., “Quarterly review: Sylvia.” “Sales charts: Walt” “Product update: Ogden,” etc. The conference session server may detect a topic based on analyzing the conversation in the conference session (e.g., a user uttering “Quarterly results are good; let us move to sales charts”) and correspondingly set the mode of the user devices associated with the corresponding persons. In this example, the user “Walt” may be in passive mode during discussion of “quarterly review,” and upon detection that the topic is now “sales charts” may be switched to active mode. Subsequently, when the conversation changes to “product update,” the device of the user Ogden may be switched to active mode, and the devices of Walt and Sylvia may be switched to passive mode.

In some implementations, a user may issue a voice command stating “Alfred, please join for discussion of product updates.” The command may be parsed by the conference session server for keywords, and a look-up operation in a database associated with the conference session server may be for the keywords. Results from the look-up operation may be used in an identification of the intended participant (e.g., “Alfred”). The conference session server may then switch the device for the identified participant that is currently in passive mode to active mode. A corresponding notification may be transmitted to the conference application associated with the user device.

In some implementations, a device identifier associated with the user device that is indicative of user location may be utilized by the conference session server to update a mode of the user device. For example, a voice command may be issued to the effect of “please join in all participants from China and Paris in active mode.” In response, the conference session server may parse the received voice command and make a determination that the command refers to a specific geography. The conference session server may perform a look-up operation to identify the user devices associated with that specific geography, and update the mode of the user devices thus identified. In some implementations, a request to update the mode of user devices associated with the specific geography may be transmitted via a screen or text based user interface (for example, using conference application 150b).

In some implementations, the request to switch to active mode may be initiated by the user. Accordingly, a suitable notification is provided to the conference session server, a user device associated with the conference session host, and/or other user device participating in the conference session. Processing continues to 260.

At 260, the user device state indicator is set to active. Upon a change of state of user device from passive mode to active mode, audio data and/or video data from the conference session is transmitted to the user device. In some implementations, the user device state may be changed from active to passive automatically based on certain triggering events. For example, a participant may choose to accept a second communication session on a second communication line while attending the conference session in active state. In some implementations, the conference session server may automatically invoke a passive state for the user device, and switch the user device state from active to passive while the second communication session in progress. The change may be implemented such that a call-on-hold feature is not activated for the other conference session participants.

In some implementations, techniques described in this disclosure may be utilized by a host of a conference session that may include participants attending the conference call at different time slots in a sequence. In a scenario where a participant's time slot may be extended thus delaying a next participant's slot leading to cascading delays, the host can initially request that all participants join in the conference session in passive mode. The host may then request that a participant update their state to active at an appropriate time. Text data may be transmitted via the conference application to specific participants to provide an intimation.

In some implementations, the conference session server may automatically invoke a passive state for the user device, and change the user device state from active to passive upon the operator of the user device accepting a notification to join a different communication session. In some example, the different communication session may be a scheduled event stored in a calendar.

It will be appreciated that 210-260 can be repeated in whole or in part or may be performed in a different order than shown in FIG. 2.

For example, in some implementations, 240 and 260 may be omitted. In some implementations, 230 and 240 may be performed after 250 and 260.

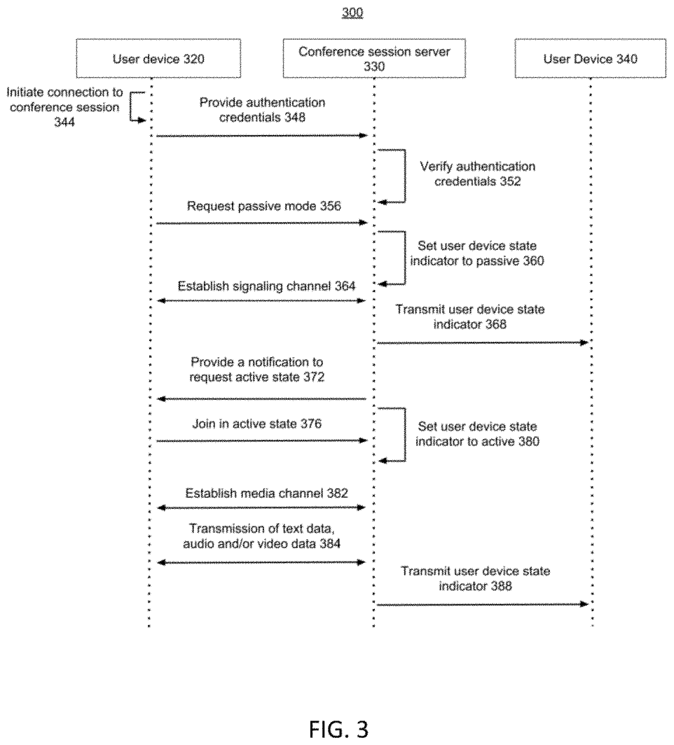

FIG. 3 is a diagram illustrating conference session management and control in accordance with some implementations.

As illustrated in FIG. 3, user device 320, conference session server 330, and user device 340 participate in a conference session. User devices 320 and 340 may be any type of user device, e.g., similar to user device 130 described with reference to FIG. 1. Conference session server 330 may be any server device, e.g., server 110 described with reference to FIG. 1.

User device 320 initiates a connection to conference session (344). Upon establishing a connection to conference session server 330, user device 320 provides authentication credentials (348). Conference session server verifies authentication credentials (352), and permits user device 320 to join the conference session.

User device 320 requests that the device be placed in passive mode (356). Upon receipt of the request, conference session server places user device 320 in passive mode (360) and sets a user device state indicator to passive. A signaling channel may be established (364) between the conference session server and the user device 320. The passive state may be characterized by non-transmission of audio and/or video data and transmission of text data from the conference session server 330 to the user device 320. The conference session server 330 transmits (368) the user state indicator to another user device 340.

The conference session server 330 provides a notification (372) to user device 320 and requests an active state. The notification may originate from a conference session server 330 or user device 340. In response to the notification, user device 320 joins in the active state (376). The conference session server 330 sets the user device state indicator to active (380). A media channel may be established (382) between the conference session server and the user device. The media channel enables (384) transmission of audio, video data and/or text data from the conference session server 330 to user device 320. The conference session server 330 transmits (388) the user state indicator to another user device 340.

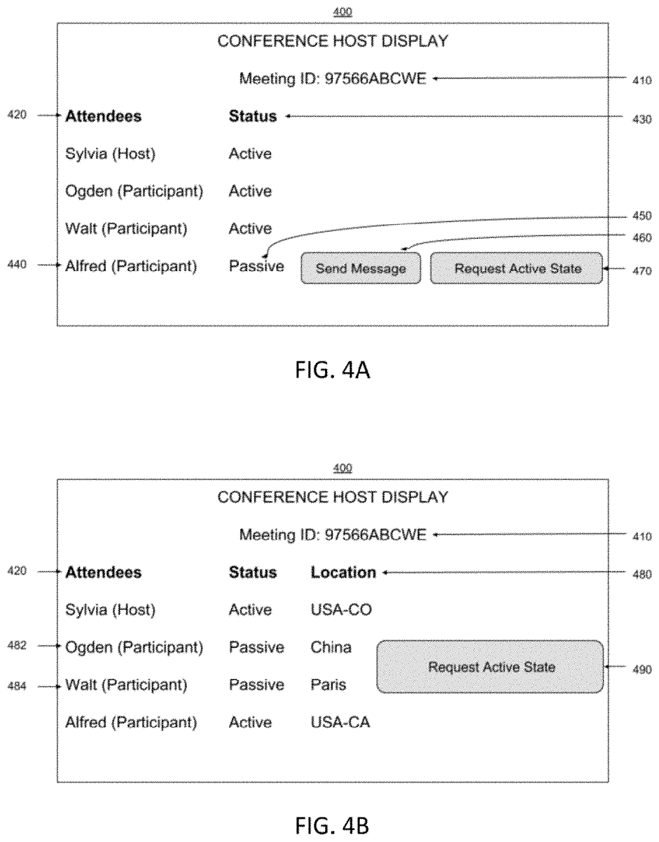

FIG. 4A is an example of a user interface for a conference host device in accordance with some implementations. In various implementations, user interface can be displayed by a display device, e.g., by a display screen of a client device 130, 135, and/or 140 of FIG. 1, or a conference session server system 110 in some implementations.

The user interface 400 may include the meeting ID (410), a list of Attendees/Participants (420), and their status (430) with respect to the conference session in progress. In the illustrated example, one of the users (440) is listed as a participant in a passive state (450). On-screen buttons may be provided for other participants and the host to send a message (460), and/or to request that the passive user join in an active state (470).

FIG. 4B is an example of a user interface for a conference host device in accordance with some implementations. In various implementations, user interface can be displayed by a display device, e.g., by a display screen of a client device 130, 135, and/or 140 of FIG. 1, or a conference session server system 110 in some implementations.

The user interface 400 may include the meeting ID (410), a list of Attendees/Participants (420), and a location identifier (480) with respect to the conference session in progress. In the illustrated example, users (482, 484) are listed as participants in a passive state, and associated with a specific geography (for example, China, Paris, etc.). On-screen buttons may be provided for other participants and the host to request that the passive users associated with the geography be joined in an active state (490).

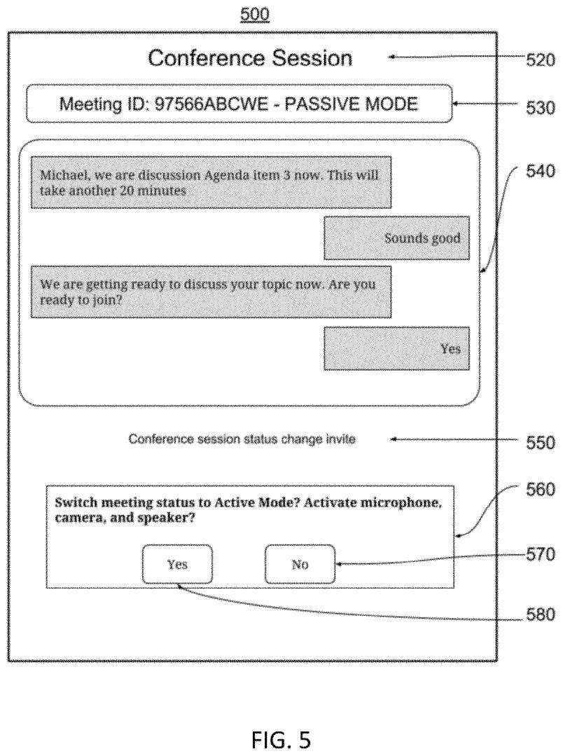

FIG. 5 is an example of a user interface for a user device in accordance with some implementations. In this illustrated example, the user interface 500 depicts an example display of user device operated by a participant in a passive state/mode. The user interface may also be provided via audio.

The display may include a reference to the conference session (520) and the user's current state (530). A text window (540) associated with conference call application may be provided to enable communication between the passive user and other users in the conference session. The information in the conference call application chat is then analyzed and when a status change request is analyzed and identified. The status change notification (550) may be provided to the user, requesting a response (560). The user may choose to either switch to active mode (580), or remain in passive mode (570).

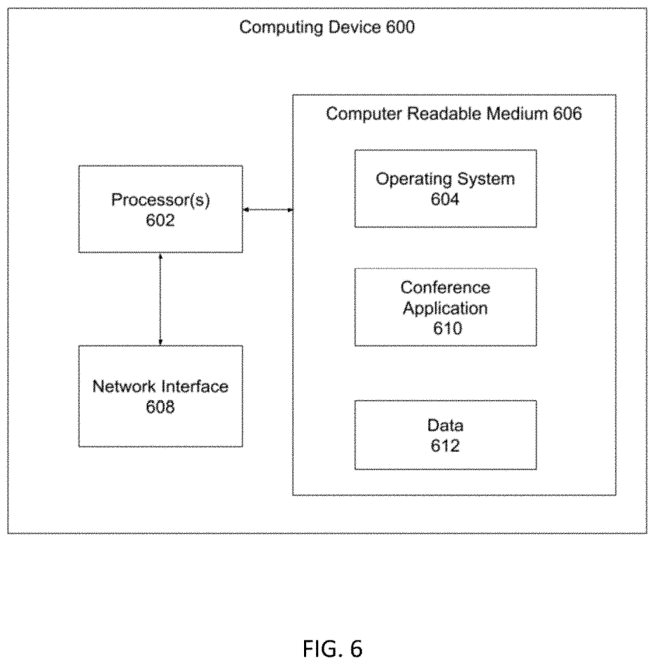

FIG. 6 is a diagram of an example computing device 600 in accordance with at least one implementation. The computing device 600 includes one or more processors 602, a non-transitory computer readable medium 606 and a network interface 608. The computer readable medium 606 can include an operating system 604, an application 610 for conference session management and control and a data section 612 (e.g., for storing policies, etc.).

In operation, the processor 602 may execute the application 610 stored in the computer readable medium 606. Application 610 can include software instructions that, when executed by the processor, cause the processor to perform operations for conference session management and control in accordance with the present disclosure (e.g., performing one or more of the sequences described above in connection with FIGS. 2 and 3). Application 610 can operate in conjunction with the data section 612 and the operating system 604.

It will be appreciated that the modules, processes, systems, and sections described above can be implemented in hardware, hardware programmed by software, software instructions stored on a non-transitory computer readable medium or a combination of the above. A system as described above, for example, can include a processor configured to execute a sequence of programmed instructions stored on a non-transitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C #.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a non-transitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hardwired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a non-transitory computer readable medium).

Furthermore, embodiments of the disclosed method, system, and computer program product (or software instructions stored on a non-transitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, methods, systems and computer readable media for conference session management and control.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. A computer-implemented method comprising:
receiving, by a server, over a network, a first request to join a conference session from a user device, wherein the first request includes a credential and an indication that the user device is to join the conference session in a passive mode;
verifying the credential received from the user device;
upon successful verification of the credential received from the user device, adding the user device to the conference session in the passive mode, wherein audio, speech to text, and video from the conference session are not transmitted to the user device in the passive mode, and wherein the passive mode is activated through a signaling channel of the network; and
setting a user device state indicator associated with the user device to passive.

2. The method of claim 1, further comprising:
determining, by the server, based on the user device state indicator, that one or more user devices in the conference session are in the passive mode;
based on the determination, ceasing transmission of media from the conference session to the one or more user devices determined to be in the passive mode; and
transmitting media to other user devices in the conference session.

3. The method of claim 1, further comprising:
receiving from the user device, via the signaling channel of the network, a second request to update a mode of the user device in the conference session to an active mode;
in response to receiving the second request, establishing a media channel of the network between the user device and the server;
transmitting at least one of the audio, the speech to text, or the video from the conference session to the user device via the media channel of the network; and
setting the user device state indicator associated with the user device to active.

4. The method of claim 3, wherein receiving the second request comprises receiving a voice command from an operator of a second user device in the conference session to update the mode of the user device, wherein the voice command is received by the server.

5. The method of claim 4, wherein receiving the second request comprises:
receiving audio from another user device in the conference session; and
detecting that the audio includes the voice command to update the mode of the user device.

6. The method of claim 5, wherein the detecting comprises:
transcribing the audio using speech recognition; and
determining that the audio includes the voice command based on matching at least a portion of the transcribed audio with a device identifier of the user device or a user identifier of a user associated with the user device, and based on detecting an activation keyword.

7. The method of claim 3, further comprising, automatically changing the user device state indicator from active to passive when at least one of:
a participant accepts a second communication session on a second communication line while attending the conference session in the active mode, wherein changing the user device state indicator does not activate a call-on-hold feature for other participants in the conference session; and
the participant accepts a notification to join a third communication session, scheduled in a calendar.

8. The method of claim 3, further comprising:
sending a notification to the user device to update the mode of the user device; and
wherein the receiving the second request is subsequent to sending the notification.

9. The method of claim 8, wherein sending the notification to the user device comprises sending a sound notification, a visual notification, a text notification, or combinations thereof.

10. The method of claim 1, wherein the credential comprises a username, a password, a conference session code, a participant identifier (ID), a biometric identifier, a caller ID, a Lightweight Directory Access Protocol (LDAP) identifier, a telephone number, or combinations thereof.

11. The method of claim 1, further comprising establishing a calling-line-identification (CLI) connection to the user device in response to successful verification of the credential received from the user device.

12. A system comprising:
one or more processors coupled to a non-transitory computer readable medium having stored thereon on software instructions that, when executed by the one or more processors, cause the one or more processors to perform operations including:
receiving over a network, a first request to join a conference session from a user device, wherein the first request includes a credential and an indication that the user device is to join the conference session in a passive mode, wherein the passive mode is activated through a signaling channel of the network;
verifying the credential received from the user device;
upon successful verification of the credential received from the user device, adding the user device to the conference session in the passive mode, wherein audio, speech to text, and video from the conference session are not transmitted to the user device in the passive mode; and
setting a user device state indicator associated with the user device to passive.

13. The system of claim 12, wherein the operations further comprise:
receiving a second request to update a mode of the user device in the conference session to an active mode; and
in response to receiving the second request, updating the mode of the user device to the active mode, wherein the active mode is activated using a media channel of the network and wherein at least one of the audio, the speech to text, or the video from the conference session are transmitted to the user device via the media channel; and
setting the user device state indicator associated with the user device to active.

14. The system of claim 13, wherein receiving the second request comprises receiving a voice instruction from an operator of a second user device in the conference session to update the mode of the user device.

15. The system of claim 12, wherein the operations further comprise:
determining, based on the user device state indicator, that one or more user devices in the conference session are in the passive mode;
based on the determination, ceasing transmission of media from the conference session to the one or more user devices determined to be in the passive mode; and
transmitting media to other user devices in the conference session.

16. The system of claim 12, wherein the operations further comprise transmitting the user device state indicator associated with the user device to other user devices in the conference session.

17. A non-transitory computer readable medium having stored thereon software instructions that, when executed by one or more processors, cause the one or more processors to perform operations including:
receiving over a network, a first request to join a conference session from a user device, wherein the first request includes a credential and an indication that the user device is to join the conference session in a passive mode;
verifying the credential received from the user device;
upon successful verification of the credential received from the user device, adding the user device to the conference session in the passive mode, wherein the passive mode is activated through a signaling channel, and wherein audio, speech to text, and video from the conference session are not transmitted to the user device in the passive mode; and
setting a user device state indicator associated with the user device to passive.

18. The non-transitory computer readable medium of claim 17, wherein the operations further comprise:
receiving a second request to update a mode of the user device in the conference session to an active mode;
in response to receiving the second request, establishing a media channel between the user device and the conference session, wherein at least one of the audio, the speech to text, or the video from the conference session to the user device are transmitted over the media channel; and
setting the user device state indicator associated with the user device to active.

19. The non-transitory computer readable medium of claim 18, wherein the operations further comprise:
sending a notification to the user device to update the mode of the user device; and
wherein the receiving the second request is subsequent to sending the notification.

20. The non-transitory computer readable medium of claim 17, wherein the operations further comprise:
receiving audio from another user device in the conference session; and
detecting that the audio includes a voice command to update the mode of the user device, wherein the detecting comprises:
transcribing the audio using speech recognition; and
determining that the audio is the voice command based on matching at least a portion of the transcribed audio with a device identifier of the user device or a user identifier of a user associated with the user device, and based on detecting an activation keyword.
